(19) United States
(12) Patent Application Publication
(10) Pub. No.: US 2023/0240487 A1
(43) Pub. Date: Aug. 3, 2023

(54) PORTABLE AUTOMATED TOILET CLEANING APPARATUS

(71) Applicant: Ronald Christopher Duncan, JR., Houston, TX (US)

(72) Inventor: Ronald Christopher Duncan, JR., Houston, TX (US)

(21) Appl. No.: 18/095,757

(22) Filed: Jan. 11, 2023

Related U.S. Application Data
(60) Provisional application No. 63/304,797, filed on Jan. 31, 2022.
(60) Provisional application No. 63/357,077, filed on Jun. 30, 2022.

(51) Int. Cl. A47K 17/00; B08B 3/02; B08B 1/04; B08B 13/00; A46B 13/02; A46B 11/06; B08B 1/00; B08B 9/093; B08B 9/087; A46B 13/00; A46B 9/00; A46B 7/04

(52) U.S. Cl. CPC A47K 17/00; B08B 3/02; B08B 1/04; B08B 13/00; A46B 13/02; A46B 11/06; B08B 1/002; B08B 9/093; B08B 9/087; A46B 13/001; A46B 9/005; A46B 7/04; B08B 2203/027; A46B 2200/304; B08B 2209/08

(57) ABSTRACT

A portable automated toilet cleaning apparatus includes a frame that fits over the toilet, and mechanical brushes or scrubbing implements that apply a scrubbing motion to surfaces of the toilet. The cleaning apparatus also includes spray jets or nozzles for directing fluid at surfaces to be cleaned. Straps may be provided to raise and hold the toilet seat and lid at angles relative to the toilet bowl, so that upper and lower surfaces of the seat and lid can be accessed by the brushes or scrubbing implements and the spray jets. A mat may also be provided at a lower side of the apparatus to collect wastewater and allow it to be poured or siphoned into the toilet bowl and disposed of by flushing.

### BACKGROUND OF THE INVENTION

### 1. Field of the Invention

The invention relates to a toilet cleaning apparatus, and in particular to an automated toilet cleaning apparatus that fits over a standard toilet and utilizes a combination of mechanical cleaning implements, such as brushes or scrubbing implements, and fluid jets to automatically scrub, disinfect, and rinse surfaces of the toilet. The brushes or scrubbing implements are arranged to rotate and/or oscillate in order to carrying out a scrubbing action, which is followed by spraying of fluid from the jets or nozzles to rinse away loosened dirt and debris. The brushes or scrubbing implements may be sprayed with cleaning fluid before performing the scrubbing action, or the cleaning fluid may optionally be applied during scrubbing via the spray jets or nozzles, or through openings in the brushes or scrubbing implements.

In an exemplary embodiment, the apparatus of the invention includes a frame and cover that encloses the toilet, supports the brushes, scrubbing implements, fluid nozzles and/or jets, and is foldable for convenient transport and storage. In order to facilitate transport and storage of the apparatus, the apparatus may fold into a suitcase or container. In addition, the frame may be adjustable to fit different toilet dimensions, and may include additional pull or slide out struts or rods for additional support.

The apparatus of the exemplary embodiment may include a fluid collection arrangement that collects wastewater after contact with surfaces of the toilet, and that allows the waste fluid to be poured or siphoned back into the toilet bowl.

In addition, the brushes or cleaning heads may consist of hollow structures with openings that enable water and/or cleaning fluid to be supplied to surfaces of the toilet through openings in the rotating main bodies of the brushes or scrubbing implements, and/or disposable elastic sleeves that hold bristles, sheets of cloth material of fabric, sponge materials, and so forth, and that fit over the hollow structures to scrub surfaces of the toilet when the brushes or scrubbing implements are rotated, the elastic sleeves being removable from the brushes or scrubbing implements when a cleaning session is completed.

Optionally, a mobile device app may be utilized to program the cleaning cycle, and to provide added features such as ordering of disposable elastic sleeves, usage tracking, memorization of frame adjustments for particular toilets, and so forth. The cleaning cycle may consist of a spray cycle in which water is directed at surfaces of the toilet, a wash cycle in which cleaning fluid is applied to the wet surfaces, and scrubbing cycle in which rotation of the brushes or scrubbing implements is initiated and the brushes or scrubbing implements are moved across the surfaces according to a programmed or predetermined scrubbing pattern.

### 2. Description of Related Art

Toilets are conventionally cleaned manually, using a scrubbing implement, cloth, or paper towels. Although frequent toilet cleaning is essential for health and aesthetics, it is unsanitary, difficult, and time consuming.

It has previously been proposed to automate the process of toilet cleaning by modifying the standard toilet to include various mechanisms for manipulating scrubbing brushes and/or fluids. Such built-in toilet cleaning devices are disclosed, for example, in U.S. Pat. Nos. 3,019,726 and 6,944,894. In general, the devices discloses in these patents include mechanism for moving the cleaning implements from a position in which the implements are extended for cleaning to a position in which the implements are retracted to permit use of the toilet. As a result, the prior built-in cleaning devices are complex and take up a substantial amount of space, greatly increasing the cost of the toilet relative to one that does not include a built-in clearing mechanism. In addition, because the devices are built-in, the previously-proposed toilet cleaning apparatus can only be used with individual modified toilets in which the devices are installed. It is not possible to clean multiple toilets with such devices, nor can the devices be used with existing unmodified toilets.

An alternative to toilet cleaning devices that are built into the toilet itself is a toilet clearing apparatus that is installed in the wall of the room in which the toilet is located, and in particular an apparatus that folds out of the wall to cover the toilet so that it can be exposed to fluid jets. Such an apparatus is disclosed in International Patent Publication No. WO2010/112655 and U.S. Pat. No. 4,718,131. However, a toilet cleaning apparatus built into a bathroom wall, like those built into the toilet itself such an apparatus can only be used with a single toilet, and furthermore has the disadvantage of requiring difficult and expensive structural modifications of the room in which the toilet is situated. In addition, such an arrangement takes up a substantial amount of space, and cannot be used in situations where space is limited. Still further, the cleaning arrangements disclosed in the PCT publication and U.S. Pat. No. 4,718,131 both require an appropriately located floor drain, which is typically not available in residential bathrooms.

Yet another alternative, disclosed in U.S. Pat. No. 3,869,732 is to provide an entire bathroom that is foldable from a position in which various fixtures, including a urinal, sink, and toilet, are situated for normal use, to a cleaning position in which the walls supporting the fixtures are folded together to form a relatively small enclosure. In the folded position, fluids from nozzles are directed to clean all of the fixtures at once. This alternative is the most costly way to automate toilet cleaning, lacks mechanical cleaning implements that might be necessary to scrub away stubborn stains, and can only be used with a single set of fixtures.

Finally, it is also known to provide free standing sealed enclosures containing a toilet and sink. After use, the entire enclosure is flooded to clean and sanitize the Interior of the enclosure, as disclosed for example in U.S. Pat. No. 3,837,011. Such free-standing self-cleaning enclosures are only suitable for use as public toilets, lack mechanical scrubbing capabilities, and cannot be used with standard toilets, whether located in a residence or other existing building or structure.

A need therefore exists for an automated toilet cleaning apparatus that is simple, inexpensive, usable with existing standard toilets, and that does not require any modifications to the existing standard toilets or the structures in which the toilets are located.

### SUMMARY OF THE INVENTION

It is accordingly a first objective of the invention to provide a fully automated toilet cleaning apparatus that can be used with a standard, previously installed and unmodified toilet.

It is a second objective of the invention to provide an automated toilet cleaning apparatus that can be used with multiple toilets at different locations in different rooms.

It is a third objective of the invention to provide an automated toilet cleaning apparatus that can be folded away for convenient transport and storage.

It is fourth objective of the invention to provide an automated toilet cleaning apparatus that is easy to set up and use, and that mechanically scrubs and disinfects all surfaces of the toilet including the toilet bowl and both upper and lower surfaces of the toilet seat and lid.

It is a fifth objective invention to provide a programmable automated toilet cleaning apparatus that allows a user to control cleaning cycles via a mobile device app.

These objectives are achieved, in accordance with principles of a preferred embodiment of the invention, by a fully automated toilet cleaning apparatus arranged to fit over a standard toilet and to be folded away when not in use.

The automated toilet cleaning apparatus of the preferred embodiment includes a frame that is unfolded by a user to cover the toilet during cleaning and that supports (i) mechanisms for positioning brushes or other scrubbing implements relative to surfaces to be cleaned, and that cause the brushes or other scrubbing implements to rotate and/or oscillate in order to scrub surfaces of the toilet, and (ii) fluid jets or nozzles for rinsing away cleaning fluid and debris or particles loosened by the brushes or scrubbing implements. Preferably, the brushes or scrubbing implements are moved away from a surface that has been scrubbed to facilitate rinsing by water sprayed from the jets or nozzles.

Optionally, the frame may be arranged to fold into and out of a suitcase or container for convenient storage or transport, and to include adjustment features that allow the dimensions of the frame to be adjusted to fit different toilet shapes and sizes. In addition, the frame may include pull or slide out members to provide extra support when in use, and/or members having wider base sections or pedestals for greater stability.

The automated toilet apparatus may also include an arrangement for lifting up and holding the toilet seat and lid in order to expose the underside of the seat and lid, and surfaces normally covered by the seat and lid, so that they can be sprayed with fluid, and a fluid collection arrangement that adheres to a surface of the toilet pedestal or floor to collect waste fluid after it has been sprayed on surfaces of the toilet, without allowing the collected fluid to flow onto the floor surrounding the toilet.

In exemplary embodiments of the toilet cleaning apparatus of the invention, mechanical arms suspended from tracks are utilized to position a brush or scrubbing implement in proximity to a surface to be cleaned, the brush is rotated and/or oscillated while being supplied with cleaning fluid to achieve a scrubbing effect, and a water jet (which may be supplied through the brush or from a separate nozzle) is used to rinse away cleaning fluid and loosened debris. For example, the mechanical arms and/or a track that extends around a periphery of the toilet bowl may be utilized to manually or automatically position a plurality of brushes or scrubbing implements relative to surfaces on the inside of the bowl, the rim of the toilet bowl, and the seat when the toilet seat and lid are raised. For simplicity, the brushes and scrubbing implements may be positioned manually, but automated positioning of the brushes and scrubbing implements is also within the scope of the invention. While the number of brushes or scrubbing implements may be varied, increasing the number of brushes or scrubbing implements has the advantage of reducing the need for movement or re-positioning of the brushes or scrubbing implements during cleaning.

Fluid is supplied to the brushes and/or the fluid nozzles or jets by a hose or that connects an input coupler on the cleaning apparatus with a water source such as a bathtub faucet, shower head, or bathroom sink, and a series of internal hoses or ducts that are supported by a frame of the apparatus and that connect the input coupler to the brushes or scrubbing implements and the nozzles or jets. The water supplied to the input connector may be further mixed with a cleaning fluid or detergent supplied by a mixing device, tank, container, manifold, chamber, or reservoir through which the water supplied by the input coupler passes on its way to the nozzles or jets. Although sufficient pressure may be achieved by appropriate design of the nozzles or jets, it is also within the scope of the invention to add an electrically-operated pump, fluid blaster, or other means for increasing the pressure of fluid exiting the nozzles. For safety, wiring should be minimized and therefore the electrical components are preferably battery powered without requiring a wired connection to an AC outlet.

The mechanism by which the seats are lifted and supported during cleaning may consist of straps that hook onto or wrap around the toilet seat and lid, and that extend to and hook onto an edge of the toilet tank, so that the seat and lid are held at angles of, for example, 5 to 25 degrees for the seat and 60 to 80 degrees for the lid. The front of the toilet seat preferably should be raised at least three inches from the upper surface of the toilet bowl to ensure sufficient space for ingress of fluid.

In addition to the number of brushes or scrubbing implement and water jets or nozzles, the positions and orientations of the brushes, scrubbing implements, jets and/or nozzles may be varied without departing from the scope of the invention, to ensure that all surfaces of the toilet that require cleaning are exposed to the brushes or scrubbing implements, and to the fluid jets or spray from the nozzles. In addition, the spray direction of the jets or nozzles is preferably adjustable to account for differences in toilet shapes or configurations.

The brushes or scrubbing implements may consist of hollow structures with openings that enable water and/or cleaning fluid to be applied to surfaces of the toilet while carrying out a scrubbing motion by rotating or oscillating the brushes. Optionally, disposable sleeves that removably fit over the hollow structures may be used to support the bristles or cloth material during cleaning. The use of removable elastic sleeves, enables the bristles or cloth material to be hygienically disposed of and replaced following use.

The used fluid or wastewater collection arrangement may be in the form of a mat made of a material that removably adheres directly to the toilet pedestal, or that includes a seal that adheres to the toilet pedestal, at a position that is raised from the surrounding floor, for example, by a distance of 1 to 6 inches. The mat itself may slope to direct fluid to a collection area or basin, or may include a drain that leads to a collection tank or container that can be manually removed after completion of cleaning so that the drained fluid can be poured by a user back into the toilet bowl for sanitary disposal by flushing. Turned-up edges or a rim may be provided around a periphery of the mat to prevent spillage onto the floor surrounding the used fluid collection arrangement.

Optionally, the waste fluid collection tank or basin may be connected to a hose that can be inserted into the toilet bowl after use in order to siphon fluid from the tank back into the toilet bowl when the toilet is flushed.

A cover for the automated toilet cleaning apparatus of the exemplary embodiment of the invention, which fits over the apparatus frame and toilet in the manner of a furniture cover, may be made of a waterproof fabric material supported by foldable frame members that maintain the shape of the cover when positioned over a toilet, that support brush positioning mechanisms and a duct or hose system that supplies fluid to the brushes and/or nozzles or jets, and that fold flat when not in use in the manner of a walker or stroller. The frame members may, for example, include four vertical supports and horizontal connecting members or crossbars that pivot relative to the vertical supports and include a detent or latching mechanism that allows the vertical and horizontal supports to (i) click into place when unfolded, and (ii) be unlatched for folding when cleaning is completed. The two vertical supports at the front of the cover may be provided with rollers that allow a position of front surface of the apparatus to be adjusted horizontally to account for different toilet sizes. Preferably, the cover has sufficient elasticity to fit securely around the back of the toilet tank hold the cover in place, and is arranged to be securely sealed to the used fluid collection arrangement at the base of the apparatus.

The foldability of the automated toilet cleaning apparatus and the optional suitcase or container allows the apparatus to easily be stored when not in use, and to be transported to clean toilets in different rooms or at different locations. The apparatus can be used with any standard toilet, and does not require modification of or retrofitting any bathroom fixtures or structures. In addition, the apparatus of the exemplary embodiment of the invention does not require a floor drain adjacent the toilet.

A mobile device app may be utilized to program the cleaning cycle, and to provide added features such as ordering of disposable elastic sleeves, usage tracking, memorization of frame adjustments for particular toilets, and so forth. This allows the seller or manufacturer of the apparatus to add features after purchase, and ensure a post-purchase revenue stream.

The programmable cleaning cycle may consist of a spray cycle in which water is directed at surfaces of the toilet, a wash cycle in which cleaning fluid is applied to the wet surfaces, and scrubbing cycle in which rotation of the brushes or scrubbing implements is initiated and the brushes or scrubbing implements are moved across the surfaces according to a programmed or predetermined scrubbing pattern.

### BRIEF DESCRIPTION OF THE DRAWINGS

FIG. 1 is a top view showing the interior of the automated toilet cleaning apparatus of a preferred embodiment of the invention.

FIG. 1A illustrates the manner in which a frame of the automated toilet cleaning apparatus may be folded into a suitcase or container.

FIG. 2 is a side view, also showing the interior of the automated toilet cleaning apparatus of FIG. 1, and additionally showing an arrangement for raising the seat and lid of a toilet for cleaning.

FIG. 3 is a cross-sectional side view of a brush or scrubbing implement for use in the preferred embodiment of FIGS. 1 and 2.

FIG. 4 is a front view of the toilet cleaning apparatus of the illustrative embodiment, after unfolding and placement over a toilet.

FIG. 5 is a cutaway view of the exemplary toilet cleaning apparatus, in the position shown in FIG. 4.

FIG. 6 is a front view of a smartphone to which an app for use with the exemplary toilet cleaning apparatus of FIGS. 1-5 has been downloaded.

### DETAILED DESCRIPTION OF THE PREFERRED EMBODIMENTS

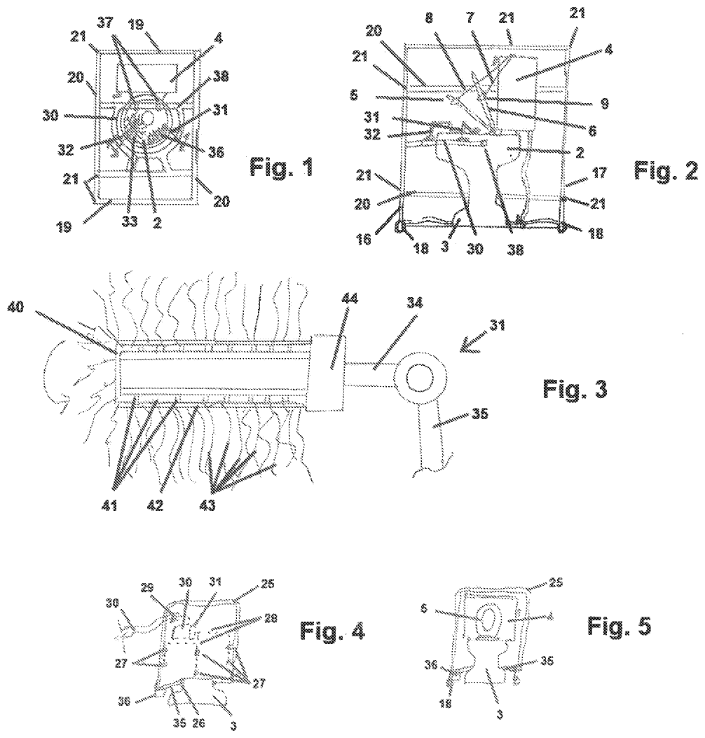

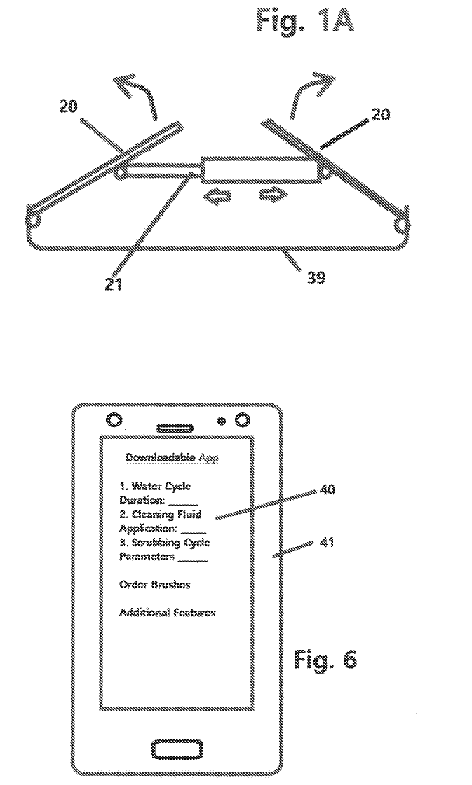

FIGS. 1 and 2 are respective top and side views showing a conventional toilet 1 having a bowl 2, a pedestal 3, a tank 4, a seat 5, and a lid 6, surrounded by the frame of a toilet cleaning apparatus constructed in accordance with the principles of a preferred embodiment of the invention. The frame of the toilet cleaning apparatus may include a at least two vertical front supports 16 and at least two vertical rear supports 17. The front supports 16 may be supported by or mounted on rollers 18, and are connected to each other by horizontal front crossbars 19 and to the vertical rear supports 17 by at least four horizontal side crossbars 20. Side crossbars 20 may include telescoping or extendable members to allow the distance between the front and rear supports to be varied. Each of the horizontal frame members is pivotally secured to the vertical supports by hinges 21 so that the frame may be folded for storage when not in use, for example into a suitcase or container 39, a section of which is shown in FIG. 1A. The apparatus preferably includes a cover 25 (FIG. 4) that fits over the frame and confines any fluids used during cleaning, as well as wastewater, to within the apparatus until the fluid is collected and directed to a drain, as explained below. It will be appreciated that the manner in which the frame is folded into a suitcase of container, the configuration of the cover, and other aspects of the support structure for the apparatus may be varied by those skilled in the art without departing from the scope of the invention. For example, the vertical supports 16 and 17 may have different dimensions from the horizontal crossbars 19 and 20, including wider sections or pedestals to provided enhanced stability, and/or the frame may include pull or slide out struts, rods, or other members (not shown) to provide increased support when the apparatus is in use.

The mechanism for positioning brushes or scrubbing implements 36 and 37 may include a track 30 for positioning the brushes or scrubbing implements relative to the bowl 2, seat 6, and lid 7, as well as one or more crossbars or shelves 38. In the illustrated embodiment, the brushes or scrubbing implements 36 and 37 are supported by arms 31 and 32, which may each be articulated to include multiple relatively-pivotal and rotatable arm segments, such as segments 34 and 35, to allow the brushes or scrubbing implements to be positioned relative to surfaces within the bowl 2, on the toilet seat 6 and on the lid 7, as well as any other surfaces that are desired to be cleaned. It will be appreciated that the numbers and positions of the arm segments 34 and 35 may be varied as necessary to enable the brushes or scrubbing implements to be moved to desired positions, and that the arms may be moved manually or automatically by appropriate motors or actuators.

The crossbars or shelves 38 may also, optionally, support one or more heaters or blow dryers (now shown), for drying the surfaces of the toilet after cleaning.

A preferred configuration of the brushes or scrubbing implements 31 and 32 is shown in FIG. 3. Each brush or scrubbing implement includes a main body 40 and a motor or actuator 44 for causing the main body 40 to rotate, oscillate (linearly or in an arc), or rotate and oscillate, to provide a scrubbing motion. In the illustrated embodiment, the main body 40 is hollow or includes ducts for supplying cleaning fluid or water to a plurality of openings 41 that enable the cleaning fluid to be applied to the surfaces being scrubbed to improve the effectiveness of the scrubbing. Once the scrubbing action is completed, dirty cleaning fluid or wastewater, as well as loosened dirt or debris, may be rinsed away by fluid jets supplied by fluid nozzles 37. Nozzles 37 may be mounted on shelves or cross bars 38, or elsewhere with the apparatus. It will be appreciated that, instead of supplying cleaning fluid through openings in the brushes or scrubbing implements, the cleaning fluid may be supplied by the jets or nozzles 37 before or during a scrubbing action, followed by supply of clean water from the jets or nozzles 37 for rinsing purposes. Preferably, the brushes or scrubbing implements are moved away from any scrubbed surfaces before rinsing, so that the brushes or scrubbing implements do not prevent the fluid jets from reaching the scrubbed surfaces.

Bristles 43, or an appropriate cloth, sponge material, mop head, or the like, are arranged to contact and apply a scrubbing action to the surfaces to be cleaned, and may be fixed directly to the main body 40 or optionally to an elastic sleeve 42 that fits securely but removably over the main body 40 to form the brush or scrubbing implement. An advantage of including the elastic sleeve is that it enables dirty or worn bristles, cloth, sponge material, and the like to be remove from the main body 40 and replaced by a new set of bristles, cloth, sponge material or the like. In addition, it allows the type of scrubbing implement to be varied by, for example, replacing brushes with a sponge or cloth, as desired.

Returning to FIG. 1, FIG. 1 also shows an arrangement by which the seat 5 and lid 6 are lifted away from the bowl 2 and supported during cleaning. The seat and lid lifting arrangement may consist of respective straps 7 and 8 that include elastic straps, one end of which clamps or hooks onto or loops around the toilet seat and lid, and a second end of which hooks or clamps an upper edge of the toilet tank 4 so that the seat and lid are held at angles of, for example, 5 to 25 degrees for the seat, and 60 to 80 degrees for the lid. The straps may optionally be secured around the seat and lid by any suitable fastener, such as Velcro™ or snap fittings. The front of the seat 5 preferably should be raised at least three inches from the upper surface of the toilet bowl 2 to ensure sufficient space for ingress of fluid. The straps 7 and 8 are positioned and secured to raise the seat and lid before placement of the toilet cleaning apparatus over the toilet 1.

As shown in FIG. 4, the cover 25 fits over the frame and also over the toilet tank 4 in the manner, by way of example and not limitation, of a furniture cover. The cover 25 is preferably made of a waterproof, stretchable, fabric material. The rear vertical supports 17 can be positioned at the front of the toilet tank 4 and the cover 25 stretched to extend over the top of the tank and to sealing engage a rear and/or sides of the tank. Gaskets (not shown) may be provided to facilitate sealing. In addition, the cover 25 extends to and is sealingly fastened to the waste fluid collection arrangement 26, described below, which may be supported by the vertical supports 16 and 17, and optionally by one or more of the lower horizontal supports or crossbars 20.

As also shown in FIG. 4, the nozzles or jets 27 are positioned on the interior of the cover and connected by ducts or hoses 28, indicated by dashed lines, to an input coupler 29. A hose 30 may be coupled to the input coupler 29 and fastened to a water source (not shown) such as a bathtub faucet, shower head, or sink faucet, by an appropriate coupler or adapter (also not shown). The input coupler 29 is connected to the ducts or hoses 28 via a mixing tank, chamber, or reservoir 30 secured to the cover or frame and into which an appropriate cleaning fluid or detergent may be poured by the user. Water from the input coupler 29 is mixed with the cleaning fluid or detergent in the mixing tank or chamber 30 and then supplied via the ducts or hoses 28 to the jets or nozzles 28, which are positioned to spray the mixed water and cleaning fluid or detergent towards, at least, inside surfaces of the toilet bowl 2, and surfaces of the raised seat 5 and lid 6.

The spray jets or nozzles 27 may include a plurality of spray jets or nozzles for directing fluid at the inside surface of the toilet bowl 2, and additional spray jets or nozzles for directing fluid at upper and lower surfaces of the toilet seat 6 and lid 7. Still further spray jets or nozzles may be provided to direct fluid at the toilet tank 4 and/or pedestal 3. The spray jets of nozzles 27 may be positioned at the front and sides of the cover or frame, and may further be supported by brackets or mounting members that enable the spray jets or nozzles to direct fluid at difficult to reach surfaces inside the toilet bowl.

Although sufficient pressure may be achieved by appropriate design of the nozzles or jets, it is preferred to add an electrically-operated pump 31, which may be positioned at the outlet of the cleaning fluid mixing tank, chamber, or reservoir 30. Preferably, the pressure-increasing pump should be battery rather than AC operated. Alternatively or additionally, fluid pressure may be applied by the nozzles themselves, either by a constricting the nozzle openings or by additional fluid pressure increasing mechanisms included in the nozzles or jets 27. The number and positions of the jets or nozzles 27, and the angle or direction of spray, may be varied without departing from the scope of the invention to ensure that all surfaces of the toilet that require cleaning are exposed to the fluid jets or spray from the nozzles. The nozzles or jets 27 may, for example, be pivotally mounted to adjust the spray direction and account for differences in toilet shapes or configurations.

As shown in FIGS. 4 and 5, the waste fluid collection arrangement 26 may be in the form of a mat 35 made of a material that removably adheres directly to the toilet pedestal, or that includes a seal that adheres to the toilet pedestal, at a position that is raised from the surrounding floor, for example, by a distance of 1 to 6 inches. The mat 35 itself may slope to direct fluid to a collection area or basin, or may include a drain that leads to a collection tank or container 36 that can be manually removed after completion of cleaning so that the drained fluid can be poured by a user back into the toilet bowl for sanitary disposal by flushing. Turned-up edges or a rim 37 may be provided around a periphery of the mat to prevent spillage onto the floor surrounding the used fluid collection arrangement. The cover 25 may be removably secured to the mat to facilitate set up, for example by a zipper.

Optionally, the collection tank or container 36 may be connected to a hose (not shown) that can be inserted into the toilet bowl after use in order to siphon fluid from the tank back into the toilet bowl when the toilet is flushed.

Because the apparatus of the illustrated embodiment is foldable, it can easily be stored when not in use, and transported and used to clean multiple toilets, which may have slightly different shapes or configurations. The apparatus can be used with any standard toilet, does not require modification of or retrofitting any bathroom fixtures or structures, and does not require a floor drain to be provided or installed adjacent the toilet.

An app 40, which may be downloaded to an mobile device such as a smartphone 41, is schematically shown in FIG. 6. The app 40 may be utilized to program the cleaning cycle, and to provide added features such as ordering of disposable elastic sleeves, usage tracking, memorization of frame adjustments for particular toilets, and so forth. This allows the seller or manufacturer of the apparatus to add features after purchase, and ensure a post-purchase revenue stream. To enable control of the apparatus using the app, the apparatus may include a controller and Bluetooth or WiFi transceiver (not shown).

The programmable cleaning cycle may consist of a spray cycle in which water is directed at surfaces of the toilet, a wash cycle in which cleaning fluid is applied to the wet surfaces, and scrubbing cycle in which rotation of the brushes or scrubbing implements is initiated and the brushes or scrubbing implements are moved across the surfaces according to a programmed or predetermined scrubbing pattern.

Although a specific embodiment of the cleaning apparatus of the invention has been described in connection with the appended drawings, it will be appreciated that details off the invention may be varied by those skilled in the art. Both the number and arrangement of the nozzles or jets, the mechanism for mixing cleaning fluid or detergent with water, and the exact configuration of the frame, cover, and fluid supply ducts or hoses may all be varied. By way of example and not limitation, the frame may include additional members or pivots, including both fixed and telescoping members. In addition, the material of the cover and the configuration of the straps that support the seat and lid during cleaning may each be varied.

Accordingly, the invention is not to be limited by the details of the illustrated embodiments, but rather is intended to encompass any modifications or variations that may occur to those skilled in the art based on the above description, and therefore is to be limited only by the scope of the appended claims.

What is claimed is:

1. A portable automated toilet cleaning apparatus that folds for transport or storage, comprising:
at least one brush or scrubbing implement configured to be positioned relative to a surface to be cleaned, and to rotate or oscillate to achieve a scrubbing motion;
a fluid jet mechanism for directing the fluid at surfaces of the toilet to be cleaned, including at least surfaces of the toilet bowl, the seat, and the pivotal lid; and
a frame that is unfolded by a user to cover the toilet during clearing, and that supports the brush or scrubbing mechanism, the fluid jet mechanism, and ducts or hoses that supply fluid to the nozzles or jets.

2. A portable automated toilet cleaning apparatus that folds for transport or storage as claimed in claim 1, wherein the brush or scrubbing instrument is supported by a positioning mechanism that enables the brush or scrubbing instrument to be manually or automatically positioned relative to a surface to be cleaned.

3. A portable automated toilet cleaning apparatus that folds for transport or storage as claimed in claim 2,
wherein the positioning mechanism for a respective brush or scrubbing implement includes an articulated arm made up of a plurality of segments that pivot and rotate relative to each other, and
wherein the articulated arm is mounted on a track positioned adjacent to and extending around the toilet bowl.

4. A portable automated toilet cleaning apparatus that folds for transport or storage as claimed in claim 1, wherein each brush or scrubbing implement includes a motor or actuator for causing the brush or scrubbing implement to rotate, oscillate, or rotate and oscillate.

5. A portable automated toilet cleaning apparatus that folds for transport or storage as claimed in claim 1,
wherein at least one brush or scrubbing implement includes a cylindrical main body to which bristles or a fabric or sponge-like cleaning member are attached, and
wherein the main body includes a plurality of apertures for passage of a cleaning fluid.

6. A portable automated toilet cleaning apparatus that folds for transport or storage as claimed in claim 5, wherein the bristles or cleaning member is attached to the main body by an elastic sleeve that is removably fitted over the main body and to which the bristles or cleaning member are fixed.

7. A portable automated toilet cleaning apparatus that folds for transport or storage as claimed in claim 1, wherein the fluid jet mechanism includes a plurality of spray nozzles or jets positioned within the cover to direct the fluid at surfaces of the toilet to be cleaned.

8. A portable automated toilet cleaning apparatus that folds for transport or storage as claimed in claim 7, wherein the spray jets or nozzles have an adjustable spray direction.

9. A portable automated toilet cleaning apparatus that folds for transport or storage as claimed in claim 7, wherein the spray jets or nozzles include nozzles or spray jets for directing fluid at an inside surface of a toilet bowl of the toilet, and nozzles or spray jets for respectively directing the fluid at upper and lower surfaces of the toilet seat and lid.

10. A portable automated toilet cleaning apparatus that folds for transport or storage as claimed in claim 7, further comprising:
a water inlet coupler configured to be coupled to a water supply hose connected to a faucet or showerhead;
a mixing chamber, tank, or reservoir connected to the water inlet coupler for mixing water with a cleaning agent or detergent; and
a plurality of ducts or hoses supported by the frame or cover for supplying the fluid from the mixing chamber, tank, or reservoir to the nozzles or jets.

11. A portable automated toilet cleaning apparatus that folds for transport or storage as claimed in claim 10, further comprising a pump or pressurizing mechanism for increasing a pressure of fluid sprayed by the nozzles or jets.

12. A portable automated toilet cleaning apparatus that folds for transport or storage as claimed in claim 11, wherein the pump or pressurizing mechanism is battery-powered.

13. A portable automated toilet cleaning apparatus that folds for transport or storage as claimed in claim 1, wherein the frame includes a plurality of vertical support members connected by horizontal crossbars attached to the vertical support members so that the frame can be folded from a position in which it fits over a toilet into a flattened assembly for transport or storage.

14. A portable automated toilet cleaning apparatus that folds for transport or storage as claimed in claim 13, wherein two of the vertical support members are mounted on wheels, and wherein a plurality of the horizontal cross bars extend or telescope to adjust a distance between front and rear ones of the vertical supports to fit toilets of different sizes.

15. A portable automated toilet cleaning apparatus that folds for transport or storage as claimed in claim 1, further comprising a cover that confines the fluid to the interior of the device during cleaning, and a fluid collection arrangement that adheres to a surface of the toilet pedestal or floor to collect the fluid after it has been sprayed on surfaces of the toilet, without allowing the collected fluid to overflow onto the floor surrounding the toilet.

16. A portable automated toilet cleaning apparatus that folds for transport or storage as claimed in claim 15, wherein the fluid collection arrangement includes a mat arranged to sealingly adhere to a pedestal of the toilet, and to which the cover is removably attached.

17. A portable automated toilet cleaning apparatus that folds for transport or storage as claimed in claim 16, wherein the mat is configured to slope downwardly towards a fluid collection basin or drain connected to a wastewater collection tank.

18. A portable automated toilet cleaning apparatus that folds for transport or storage as claimed in claim 15, wherein the cover is made of an elastic fabric material.

19. A portable automated toilet cleaning apparatus that folds for transport or storage as claimed in claim 1, wherein the wastewater collection tank is configured to be disconnected from the drain to enable collected wastewater to be poured from the tank back into the toilet bowl.

20. A portable automated toilet cleaning apparatus that folds for transport or storage as claimed in claim 1, further comprising an arrangement for lifting up and holding a seat and lid of a toilet to be cleaned in order to expose the underside of the seat and lid, and surfaces normally covered by the seat and lid, so that they can be sprayed with a fluid.

21. A portable automated toilet cleaning apparatus that folds for transport or storage as claimed in claim 20, wherein the arrangement for lifting up and holding the seat and lid of the toilet includes respective straps for the seat and lid.

22. A portable automated toilet cleaning apparatus that folds for transport or storage as claimed in claim 21, wherein the straps are secured to the lid and seat by clamps and or hooks that respectively secure the straps to the toilet tank, the lid, and the seat.

23. A portable automated toilet cleaning apparatus that folds for transport or storage as claimed in claim 21, wherein at least one of the straps is secured to the seat and/or lid by looping the straps around the seat and lid and securing the loops by a fastener.

24. A portable automated toilet cleaning apparatus that folds for transport or storage as claimed in claim 21, wherein the seat and lid are held by the straps at an angle of, for example, 5 to 25 degrees for the seat and 60 to 80 degrees for the lid.

25. A portable automated toilet cleaning apparatus that folds for transport or storage as claimed in claim 20, wherein a front of the seat is raised and held by a respective strap at least three inches from an upper surface of the toilet bowl to ensure sufficient space for ingress of fluid.

26. A portable automated toilet cleaning apparatus that folds for transport or storage as claimed in claim 1, wherein the frame folds into a suitcase or container for storage and transport.

27. A portable automated toilet cleaning apparatus that folds for transport or storage as claimed in claim 1, further comprising a mobile device app for setting and controlling a cleaning cycle and providing additional value-added features.
